(19) United States
(12) Patent Application Publication
(10) Pub. No.: US 2015/0032700 A1
(43) Pub. Date: Jan. 29, 2015

(54) ELECTRONIC INTERACTIVE PERSONAL PROFILE

(71) Applicant: Yakov Z. Mermelstein, Spring Valley, NY (US)

(72) Inventor: Yakov Z. Mermelstein, Spring Valley, NY (US)

(21) Appl. No.: 13/948,768

(22) Filed: Jul. 23, 2013

(51) Int. Cl. G06F 21/62

(52) U.S. Cl. CPC G06F 21/6218
USPC 707/687; 707/781

(57) ABSTRACT

The invention involves an interactive live verified profile. Any type of information can be stored in the profile, such as text, audio, video, graphics, etc. The owner of the profile then designates which information can be seen by which people. Most importantly, before being made available, the information is verified. The people who are designated to see the important also get the benefit of automatically getting updates when information is changed, modified, or updated

### FIELD OF THE INVENTION

This invention relates to the electronics and communications industry and, more particularly, to an electronic interactive personal profile.

### BACKGROUND OF THE INVENTION

A centuries old method of providing contact information is to distribute a calling/business card. Typically, all of a person's relevant contact information is provided. In prior centuries, it may have included just a name and an address. In the 20^{th} century, phone numbers were added. A 21^{st} century innovation is to add an e mail address and maybe also a website address.

The concept of a business card has been embellished by means of the Internet. Not only contact information, but also any desired information can be stored in a file and made available to selected people.

Facebook has an Internet facility that allows users to create a file of any information and to make that information accessible to only selected persons. Zuckerberg (U.S. Pat. No. 8,225,376) discloses a method for dynamically generating a privacy summary. A profile for a user is generated. One or more privacy setting selections are received from the user associated with the profile. The profile associated with the user is updated to incorporate the one or more privacy setting selections. A privacy summary is then generated for the profile based on the one or more privacy setting selections.

The Facebook interface does not specifically allow a person to download any of the posted information. A “friend” can see the information, but cannot download to his computer. Moreover, a “friend” has to always check to see if the information is current, because the Facebook platform does not automatically update the information for “friends” when the user updates his own information.

Shustef (U.S. Pat. No. 8,370,482) discloses an information management and distribution method and system for updating contact information over a network. A plug-in associated with a cloud-based back-end unit interacts with a Web application. A virtual card comprising a set of pluggable user interface components associated with the plug-in can be displayed in a user interface associated with the Web application. The contact information with respect to a user can be updated and automatically distributed to other users associated with the Web application that is configured with the virtual card plug-in module. The back-end unit can be employed to keep track of the contact information in a database and provide management functions associated with the data via a Web services application programming interface. A hard copy version of the virtual card can also be rendered utilizing a variable data composition engine and a rendering technology.

Swan (U.S. Pat. No. 8,306,506) discloses wireless and standalone handheld devices, such as PDAs and wireless telephones, that are configured for inputting a unique contact identifier that uniquely identifies a desired contact record, querying a central database of contact information to obtain the desired contact record, receiving the record and storing it. In various embodiments, such requests can be made directly over a wireless network or indirectly when synchronizing the handheld device with a computer connected to the Internet or to another network.

Gropper (U.S. Pat. No. 8,032,549) discloses an Internet-based system capable of automatically maintaining contact-related information in any computer software application or digital device which stores or manages contact-related information. More particularly, the system allows users to automatically enter and maintain contact-related information in a digital address book or similar application or device (such as a wireless phone or PDA) with minimal or no manual entry of the contact-related information by the user. The system also allows contacts of the user (i.e. people who's contact information or partial contact information is present in the user's address book application) to make corrections to their contact-related information contained in the user's address book, request reciprocal contact information from the user, deny the user access to additional or corrected contact-related information and take other actions relative to managing the contact-related information which others (users) have about them.

Feldhahn (U.S. Pat. No. 7,246,099) discloses a method and system that allows individuals to maintain current contact information in another individual's contact software without having to individually notify the receiving individual or manually resend the updated contact information to the individual. The invention does this by utilizing an existing platform for the distribution of static contact information (the v-Card platform), and through the means of storing static contact information for an individual on a central server and then assigning a globally unique ID to the individual and his information. The invention includes in the static contact information created by an individual, a dynamic link containing a creator's globally unique ID that may be utilized by recipients of the contact information to retrieve updated contact information at any future time.

While any type of information can be made available through these “information” sharing sites, like Facebook, there are limitations. In particular, information is not verified before it is available for viewers. Hence, viewers may obtain incorrect information

Therefore, there is a need in the industry for the available information to be verified before it is available to designated users. These users should also be able to suggest information and add material.

### SUMMARY OF THE INVENTION

These and other objects of the invention are achieved with a verified active information profile wherein certain information can be downloaded by designated persons. In addition, this downloaded information is updated each time the information in the primary personal profile is changed.

According to the Invention, in its simplest, basic form, it involves an interactive live verified profile. Any type of information can be stored in the profile, such as text, audio, video, graphics, etc. The owner of the profile then designates which information can be seen by which people. Most importantly, before being made available, the information is verified. The people who are designated to see the important also get the benefit of automatically getting updates when information is changed, modified, or updated.

In the preferred embodiment, the method of making information available to designated people, includes: Creating a file of information and storing it in a universally accessible electronic location; Designating persons who may have access to said information; and Permitting said designated persons to download selected information to a personal storage file of said designated persons; and wherein the improvement comprises said information being verified prior to it being available to said designated persons.

Another embodiment of the Invention includes a method of identifying a person's location and/or status and making that information available to designated people, which includes: Creating a file of information and storing it in a universally accessible electronic location; Identifying a location and/or a status of a person and storing the location and/or status in the file of information; and Designating persons who may have access to said information, including the location and/or the status. Preferably, Identifying a location of a person includes using a global positioning system to determine a physical location of a personal electronic device of the user and embedding that location information in the file of information

Other objects, features and advantages of the present invention will become apparent upon reading the following detailed description in conjunction with the drawings and the claims.

### BRIEF DESCRIPTION OF THE DRAWINGS

For a better understanding of the invention, its operation and specific objects attained by its uses, reference should be had to accompanying drawings and descriptive matter in which there are illustrated preferred embodiments of the invention.

The invention will now be described in connection with certain preferred embodiments with reference to the following illustrative figures so that it may be more fully understood.

FIGS. 1-4 are flow charts, showing the process of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention

According to the Invention, in its simplest, basic form, it involves an interactive live verified profile. Any type of information can be stored in the profile, such as text, audio, video, graphics, etc. The owner of the profile then designates which information can be seen by which people. Most importantly, before being made available, the information is verified. The people who are designated to see the important also get the benefit of automatically getting updates when information is changed, modified, or updated.

As with electronic business card, this profile necessarily includes all identifying and contact information of the person. In other words, it has his contact profile. Instead of the card being physical, it is stored either in an Internet cloud or in a web server.

If a person wants some or all of the information of someone, he signs onto the cloud (or server) and then searches by name and obtains it. He may then access it from the cloud or he may download it to a server or to his personal electronic device (like a smart phone, IPad or PDA). It is like adding another person's information stream to your personal files, so, whenever you change a smart phone or computer, you just log in to your information stream and all your information is imported and updated to your current device.

Another aspect is that when a person changes his information, such as contact information or employment affiliation, it is automatically changed on the electronic profile, so that anyone who has access to his information stream automatically has the updated information. Further, when a person is traveling or otherwise unavailable, the profile can be set to stream a notice that the person is unavailable or to provide a temporary alternate phone number etc.

In the preferred embodiment, the method of making information available to designated people, includes: Creating a file of information and storing it in a universally accessible electronic location; Designating persons who may have access to the information; and Permitting the designated persons to download selected information to a personal storage file of the designated persons; and wherein the improvement comprises the information being verified prior to it being available to the designated persons.

The type of information that may be stored in this user profile (the file of information) is unlimited. It may be simple biographic information, like phone, e mail, address, birthday etc. Photos may be included. Audio and/or audio/video materials may be stored. For example, a user could store an audio/video film of a certain event—maybe a wedding or a birthday celebration. Graphics could be included. An artist might attach reproductions of their paintings.

All data or information that is entered is verified. According to the invention, the information is verified prior to it being available to said designated persons.

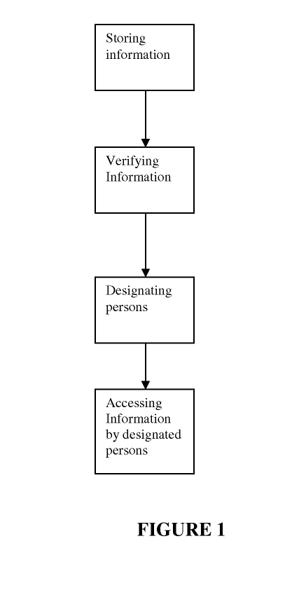

In the preferred embodiment of the invention (FIG. 1), first there is creation of a file of information and storing it in a universally accessible electronic location. Preferably, the universally accessible electronic location is located on an Internet cloud. Alternatively it could be located on any suitable server. The point is that it must be in a location where a myriad of people can get access to it.

The next step is a little like Facebook. In particular, the user or owner of the profile designates persons who may have access to the information. This may involve separating the profile into fields or categories and defining categories of viewing persons.

For example, information in the profile may be divided in any number of ways. One way is to separate into personal and professional information. Another could be to separate according to interests, like a club or a sport. A person could designate his “baseball” information or his “stamp” information or his “synagogue” information. People may be divided into categories, such as friends, real friends, close relatives, relatives, synagogue friends, professional contacts. For each category of people the user then designates which category(s) of information they may see.

These designated persons may now sign onto the universally accessible electronic location (i.e. the Internet cloud) anytime they wish. Then they go to the user's profile and sign in with their security code or password. This allows them to see any and all information that is designated for their viewing.

The process then permits the designated persons to download selected information to a personal storage file of that designated person.

If desired, they may download some or all of that information to their personal storage device or portable electronic device, which may typically be a smart phone or IPad or PDA.

For purposes of the invention, the term portable electronic device includes any portable device that may be used for electronic communication, including, but not limited to, mobile devices, cell phones, smart phones, hand held computers, laptop computers, palm top computers, personal digital assistant (PDA), electronic pads and/or tablets.

The improvement as compared to the prior art is that the information is verified prior to it being available to the designated persons

It should be appreciated that it is not critical at what point the information is verified as long as it is before the designated persons see it. Hence, the information can be verified before viewers are designated or afterwards. Information can be verified at the time it is entered in the profile or at some later time. It does not matter when it is verified. The critical issue is that it needs to be verified before the designated persons see it.

In some embodiments, at least a portion of the information is verified by a 3^{rd} party before the designated persons can access and download information.

Verification can be by either the owner of the profile or a 3^{rd} party or both. For example, professional information may be verified by an employer.

Any suitable method may be used for verification and several procedures are known in the trade. For example a phone number can be tested by an SMS message. E mails can be checked by sending text e mails. GPS can be used to check physical addresses.

An unique aspect of the invention is that in some embodiments at least a portion of the information can be provided by a 3^{rd} person before designated persons can access and download information. For example, a person viewing the profile may suggest that the profile owner add information about his work with the Boy Scouts. A relative may recommend adding a genealogical tree. In some cases 3^{rd} persons may add information. A cousin may add the names and places of birth of great grandparents. It is possible for an employer to add employment information.

Preferably the portion of information provided by a 3^{rd} person is verified by the user before the designated persons can access and download the information.

Another aspect of the invention is that designated persons can suggest additional subject matter to be included in the profile's information. This is another distinguishing feature from the prior art. Included within this concept is that the designated person may suggest additional fields or categories as well as provide the actual content.

According to another aspect of the invention, it is possible to synchronize information stored on the universally accessible electronic location and previously downloaded information stored in personal storage files of the designated persons. This means that, regardless of from what platform you access the data, it will always be current and update. Synchronization is common for electronic address books and calendars which a person may access from multiple devices.

This process may be especially suitable for companies. Profiles can be created for employees according to job title, for example. A profile for the salesman Moshe may be created and used for a period of time. Then, Yossi may replace Moshe. Instead of creating a new profile, the company just changes the name title on the profile and they can continue to use the profile for Yossi.

Therefore, the file of information can be configured to permit changing a name designation of a user storing said information in the universally accessible electronic location.

An entity can maintain the file of information of the user in a name of a specified position and/or title.

In another embodiment, an entity can maintain the file of information of the user in a name of an identified person; and, upon the identified person becoming dissociated with the entity, the entity changes the name designation of the user to a name of a replacement of the identified person.

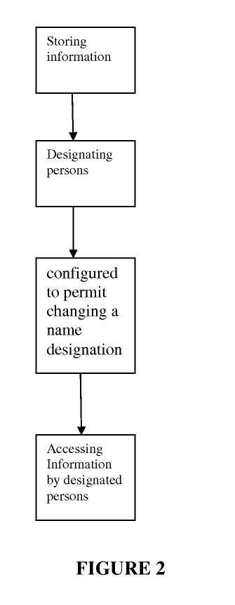

The process of making the file or profile available with the file of information being configured to permit changing a name designation of a user storing the information in the universally accessible electronic location can be accomplished with or without verification. (see FIG. 2) This concept is in of itself new and novel.

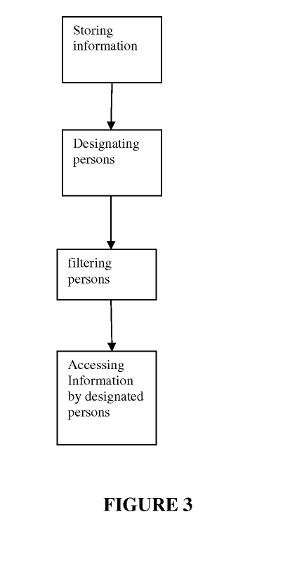

Another aspect of the invention, which may operate with or without verification, is the ability of specifying persons from whom a user will accept communications. (see FIG. 3) What this means is that a user can designate from which people he wishes to receive communications. For example, he may wish to receive communications from friends but not relatives, or visa versa.

The user can define subject matter of the communications that he will accept from specified persons. Wedding invitation may be acceptable, but not High School reunions.

According to this concept the user can filter the content of what he receives and also filter the persons from who he will receive information. In particular, the user can filter persons from whom a user will accept or not accept communications and/or filter subject matter of the communications.

Still another way to utilize this procedure is with forms.

More particularly, via API, the method includes linking fields from your Profile to the appropriate fields in the Forms. This means that at the entities' servers (such as a bank or utility company) there is live synchronization of the fields. If there are fields in the form that are not in the profile, they can be added to the profile. When filling in these new fields and submitting the form, the user has automatically authorized and added these new fields to the profile and linked them.

The method, therefore, further includes linking fields in an API form with fields in the file of information. This includes synchronization of the fields in an API form with fields in the file of information.

An application programming interface (API) specifies how some software components should interact with each other. In practice in most of the cases an API is a library that usually includes specification for routines, data structures, object classes, and variables. An API specification can take many forms, including an International Standard such as POSIX, vendor documentation such as the Microsoft Windows API, the libraries of a programming language, e.g., Standard Template Library in C++ or Java API.

Further, API allows a person to lift the information in his form and embed it in his profile.

The practice of publishing APIs has allowed web communities to create an open architecture for sharing content and data between communities and applications. In this way, content that is created in one place can be dynamically posted and updated in multiple locations on the web. Content can be dynamically posted. Sharing live comments made on Twitter with a Facebook account, for example, is enabled by their APIs. Photos can be shared from sites like Flickr and Photobucket to social network sites like Facebook and MySpace. Content can be embedded, e.g. embedding a presentation from SlideShare on a LinkedIn profile. Video content can be embedded on sites served by another host. User information can be shared from web communities to outside applications, delivering new functionality to the web community that shares its user data via an open A.

Using API protocols, two other unique aspects of the invention can be achieved. There can be embedding of content from an API compatible form into the file of information (i.e. the profile). Second, there can be embedding of applicable content from the file of information (the profile) into an API compatible form.

By use of API it is possible to link the fields in a form with the fields in the profile.

Another unique application is combining this profile with GPS.

The term Global Positioning System should also include any communication system that helps the device determine location, and it is not limited to and may include “WIFI,” “Bluetooth,” “NFC” and/or “GPS.” Herein after the term GPS is being used to include all these applicable protocols for global positioning.

On most personal electronic devices (as defined above), there is GPS capability. This means that at any given time a person's personal electronic device knows exactly where the device is and, therefore, where the user is located.

One of the profile fields can thus be a person's GPS location. Persons who have been given access to this field can instantly now where there the user is located. This is an improvement on the “away message” used on Facebook. On Facebook the user has to log onto Facebook and enter an appropriate location. Here the user does nothing at all. The GPS protocol on his personal electronic device automatically inserts the user's location into an appropriate field in the profile. In this manner specified people (like parents, spouse, and children) can know in real time where a person is.

The GPS protocol can be set to embed a new location when a person has moved a certain distance from a prior location. If the GPS determines the person is in motion (such as in a car, a bus, a plane or even just walking), it can indicate he is traveling from a certain place. Once motion stops, it inserts his location.

For example, the profile can now tell designated person where the user is—Yankee Stadium, Smithsonian Air & Space Museum or even on Delta Airlines Flight XXX from New York to London. It can identify that a person is walking north from the New York Public Library on 42^{nd} Street. When he arrives at Rockefeller Center, it will now reflect that he is located there.

Still another unique aspect is to generate an automatic status field in the profile.

For example, a person's status and/or location can be automatically copied into a status field in the profile from the person's electronic calendar. If a person is engaging in a phone call, his status may be marked as “busy” or as “on the phone.”

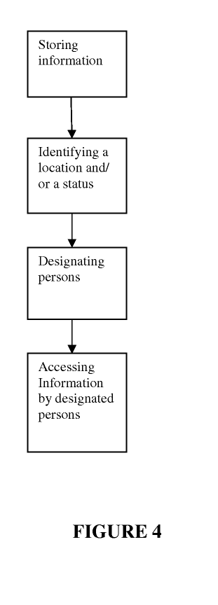

According to this embodiment of the Invention (FIG. 4), the method of identifying a person's location and/or status and making that information available to designated people, includes: Creating a file of information and storing it in a universally accessible electronic location; Identifying a location and/or a status of a person and storing the location in the file of information; and Designating persons who may have access to said information, including the location and/or the status. Preferably, Identifying a location of a person includes using a global positioning system to determine a physical location of a personal electronic device of the user and embedding that location information in the file of information.

In the preferred embodiment, the global positioning system will not update the location until the person has moved a predetermined distance from a prior location. For example, if a person is at a museum or Yankee stadium or a major university, he may move around within the premises, and so his position has technically changed, but he is still at the same place. Therefore, the GPS may be set, for example, to not change a person's position until he has moved, for example, 100 meters or maybe half a kilometer.

The global positioning system also determines a mode of movement of the person and embeds that mode of movement in said file of information. In addition the global positioning system can determine a direction of movement of the person and embeds the direction of movement in the file of information. This allows the profile to, for example, indicate a person is walking north on Fifth Avenue or he is flying across the Atlantic from New York toward London.

Still another unique aspect is to include a unique electronic identifier in the profile. This identifier acts like a PIN number. The user of the profile can selectively distribute this electronic identifier (or PIN number) to selected people and they, in turn, may use it to access the profile.

Therefore, the method includes entering an electronic identifier into the file of information, whereby designated persons can access the file of information by means of the electronic identifier.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A method of making information available to designated people, comprising: Creating a file of information and storing it in a universally accessible electronic location; Designating persons who may have access to said information; and Permitting said designated persons to download selected information to a personal storage file of said designated persons; and wherein the improvement comprises said information being verified prior to it being available to said designated persons.

2. A method according to claim 1, wherein at least a portion of said information first being verified by a 3^{rd} party before designated persons can access and download information.

3. A method according to claim 1, wherein at least a portion of said information being provided by a 3^{rd} person before designated persons can access and download information.

4. A method according to claim 3, wherein said at least a portion of said information provided by a 3^{rd} person being verified by a user before designated persons can access and download information.

5. A method according to claim 1, further comprising: designated persons suggesting additional subject matter to be included in said information.

6. A method according to claim 1, wherein said universally accessible electronic location is located on an Internet cloud.

7. A method according to claim 1, further comprising: synchronizing information stored on said universally accessible electronic location and previously downloaded information stored in personal storage files of designated persons.

8. A method according to claim 1, further comprising said file of information being configured to permit changing a name designation of a user storing said information in said universally accessible electronic location.

9. A method according to claim 8, further comprising
A. An entity maintaining said file of information of said user in a name of an identified person; and
B. Upon said identified person becoming dissociated with said entity, said entity changing said name designation of said user to a name of a replacement of said identified person.

10. A method according to claim 8, further comprising an entity maintaining said file of information of said user in a name of a specified position and/or title.

11. A method of making information available to designated people, comprising: Creating a file of information and storing it in a universally accessible electronic location; Designating persons who may have access to said information; and Permitting said designated persons to download selected information to a personal storage file of said designated persons; and wherein the improvement comprises said file of information being configured to permit changing a name designation of a user storing said information in said universally accessible electronic location.

12. A method according to claim 11, further comprising said information being verified prior to it being available to said designated persons.

13. A method according to claim 11, further comprising
A. An entity maintaining said file of information of said user in a name of an identified person; and
B. Upon said identified person becoming dissociated with said entity, said entity changing said name designation of said user to a name of a replacement of said identified person.

14. A method according to claim 11, further comprising an entity maintaining said file of information of said user in a name of a specified position and/or title.

15. A method according to claim 1, further comprising filtering persons from whom a user will accept or not accept communications.

16. A method according to claim 15, wherein said user can filter subject matter of said communications.

17. A method of making information available to designated people, comprising: Creating a file of information and storing it in a universally accessible electronic location; Designating persons who may have access to said information; and Permitting said designated persons to download selected information to personal storage files of said designated persons; and wherein the improvement comprises filtering persons from whom a user will accept or not accept communications.

18. A method according to claim 17, further comprising said information being verified prior to it being available to said designated persons.

19. A method according to claim 1, further comprising linking fields in an API form with fields in said file of information.

20. A method according to claim 19, further comprising synchronization of the fields in an API form with fields in said file of information.

21. A method according to claim 1, further comprising embedding content from an API compatible form into said file of information.

22. A method according to claim 1, further comprising embedding applicable content from said file of information into an API compatible form.

23. A method according to claim 1, further comprising entering an electronic identifier into said file of information, whereby said designated persons can access said file of information by means of said electronic identifier.

24. A method of identifying a person's location and/or status and making that information available to designated people, comprising: Creating a file of information and storing it in a universally accessible electronic location; Identifying a location and/or a status of a person and storing said location in said file of information; and Designating persons who may have access to said information, including said location and/or status.

25. A method according to claim 24, wherein Identifying a location of a person includes using a global positioning system to determine a physical location of a personal electronic device of said user and embedding said location information in said file of information.

26. A method according to claim 25, wherein said global positioning system will not update said location until said person has moved a predetermined distance from a prior location.

27. A method according to claim 25, wherein said global positioning system determines a mode of movement of said person and embeds said mode of movement in said file of information.

28. A method according to claim 25, wherein said global positioning system determines a direction of movement of said person and embeds said direction of movement in said file of information.

29. A method according to claim 24, wherein Identifying a location and/or a status of a person includes automatically copying into a status field in the file of information status and/or location from said person's electronic calendar.
